(19) United States
(12) Patent Application Publication
(10) Pub. No.: US 2014/0049443 A1
(43) Pub. Date: Feb. 20, 2014

(54) Extendable Loop Antenna for Portable Communication Device

(71) Applicant: Daniel A. Katz, Kiryat Ono (IL)

(72) Inventor: Daniel A. Katz, Kiryat Ono (IL)

(73) Assignee: Daniel A. Katz, Kiryat Ono (IL)

(21) Appl. No.: 13/585,863

(22) Filed: Aug. 15, 2012

(51) Int. Cl. H01Q 7/02

(52) U.S. Cl. 343/871

(57) ABSTRACT

The present invention discloses a wireless communication device with an extendable planar antenna. The antenna is made of a radiating loop, and a ground plane, wherein the loop is parallel to the ground plane and the distance between the loop and the ground plane is configurable, attaining at least two positions: a stowed position where the loop is close to the ground plane, and an operational position where the loop moves apart from the ground plane, to improve the antenna radiation properties. According to one embodiment, this wireless device is a Personal Locator Beacon (PLB) for Search and Rescue (SAR) of people in distress, configured to be wrist worn.

### BACKGROUND OF THE INVENTION

The present invention relates to wireless communications and particularly to Radio Wave Antennas.

Efficiency of a transmitting antenna is usually defined as the ratio between the power the antenna radiates and the power put into the antenna by a coupled transmitter. Obviously, a high efficiency is usually desirable in an antenna.

The physical size of an antenna, normalized to its operating wavelength, usually refers in the art as the “electrical size” of the antenna, so a “small antenna” usually (including in the present document) means an Electrically Small Antenna (ESA). Clearly, small antennas are desirable, particularly in mobile and portable devices.

Ideally, a small and efficient antenna should be designed for most wireless devices, however, a well known rule trades off between these two parameters, limiting the miniaturization of the electrical size of an antenna, for a given efficiency. This rule also indicates that at least one of the antenna dimensions should be not less than λ/4, where λ (lambda) is the transmission (or reception) wavelength, to achieve efficient radiation. This leads, for example, in one dimensional antennas (“whip” or “rod” shaped) to λ/4 monopoles (over a ground plane), such as 18.5 cm monopole for 406 MHz radios.

Clearly, smaller than λ/4 antennas can be configured, yet this usually degrades the antenna efficiency. Thus, an efficient antenna for a relatively low frequency (i.e. long wavelength) is not easily achieved in small dimensions.

Over the years, more complex shapes of antennas, many of them three dimensional, were been studied. Some fundamental works were been published by Wheeler [H. A. Wheeler, “Fundamental Limits of Small Antennas,” Proceedings of The I.R.E. (IEEE), December 1947, pg. 1479-1484], Chu (Chu, L. J, “Physical Limitation of Omni-Directional Antennas”, Journal of Applied Physics, Vol. 19, p. 1163-1175, 12/1948) and others. Based on these works, theoretical arguments predict that the minimal size for practical antennas will require a volume of half a sphere with a radius r, where kr=0.3 (k=2π/λ). For example, at 406 MHz this means a radius r of ˜4 cm. In part of the literature the radius of this sphere is named a instead of r, so ka=0.3 is considered the minimum figure for an efficient ESA.

As well known in the art, one of the disadvantages of ESAs is a narrow bandwidth, which is related to a high Q (quality factor). The minimum Q of an ESA was studied by James S. McLean, and published in “A Re-Examination of the Fundamental Limits on The Radiation Q of Electrically Small Antennas,” IEEE Transactions on Antennas and Propagation Vol 44, NO. 5, May 1996, pg. 672-675. McLean expressed the minimum Q for an ESA in free space, for linear or circular polarization, as a function of ka. As expected, Q increases as ka decreases, i.e. as an ESA gets smaller, its bandwidth gets narrower.

Furthermore, in almost any practical environment an electrically small antenna is near some type of ground plane or other structure and not in free space. This more practical case was studied by Randy Bancroft from Centurion Wireless Technologies, Westminster, Colo. and published in: “Fundamental Dimension Limits of Antennas Ensuring Proper Antenna Dimensions in Mobile Device Designs”=http://www.cs.berkeley.edu/˜culler/AIIT/papers/radio/antenna%20wp_dimension_limits.pdf

Another important paper that studies the ESAs Q in the environment of a ground plane was published by Johan C. E. Sten, Arto Hujanen, and Paivi K. Koivisto, named: “Quality Factor of an Electrically Small Antenna Radiating Close to a Conducting Plane,” IEEE Transactions on Antennas and Propagation, VOL. 49, NO. 5 May 2001, pp. 829-837.

The above mentioned publications show that the bandwidth of the horizontal polarization (Hpol) of an ESA close to a ground plane decreases significantly, compared to Hpol radiation in free space.

Obviously, a narrow bandwidth is inconvenient. Even if coupled to a wireless device configured to operate within this band, the antenna might still detune due to rain, snow, dust etc.

It is therefore not easy to design a small antenna (ESA), efficient and wide band, operating in the vicinity of a ground plane, particularly an antenna that radiates most of its energy horizontally, as many planar antennas do.

Not surprisingly, the present art covers several methods to configure antennas, composed of relatively movable parts or of flexible material so that could be folded or collapsed to occupy less space when not in use. Such methods are particularly popular in the military and satellite communications, for obvious reasons.

U.S. Pat. No. 4,115,784 to Schwerdtfeger, et al. discloses a Deployable ground plane antenna. Schwerdtfeger claims “a deployable ground plane antenna . . . said ground plane being made of collapsible material . . . said ground plane in either a deployed condition radially extending . . . or in a collapsed condition wrapped around . . . ”

U.S. Pat. No. 5,909,197 to Heinemann et al. discloses a Deployable helical antenna stowage in a compact retracted configuration. Heinemann discloses a compressible and deployable antenna comprised of a top and a bottom plate, and a deployable structure fitted between the plates which can forcibly separate the plates and extend a helical antenna placed between the plates.

None of these teach planar radiating elements that move in parallel to a ground plane.

In the recent years, portable communication devices for personal use were introduced to the market, still operating at relatively low frequencies, such as VHF and low UHF (more rarely HF). One typical type of such device is PLB (Personal Locator Beacon) for SAR (search and rescue) of people in distress. Some of these PLBs operate at 121.5 MHz, i.e. λ=247 cm. Another family of PLBs operate at 406 MHz, i.e. λ=74 cm. For such a wavelength, a λ/4 antenna compact enough to be constantly carried by a person is not likely, so usually smaller than λ/4 antennas are introduced, compromising antenna parameters such as efficiency and bandwidth. However, deployable or collapsible antennas may provide a fair solution, since could be most of the time stowed in a low volume, and deployed, when needed, for full performance.

U.S. Pat. No. 5,559,760 to Schneider (Breitling), discloses a wristwatch comprising, in addition to a device for measuring and displaying the time, a high-frequency transmitter and an extensible antenna in the form of two wires wound up in two different housings of the watch before use; the antenna being unfurled by pulling on plugs fastened to each end of the antennas. The dipole antenna of this device is configured that once been extended, does not flex but remains straight.

Yet, this method might be problematic since such a whip dipole antenna is quite long for VHF/UHF bands.

U.S. Pat. No. 7,586,463 to Katz discloses Extendable helical antenna for personal communication device. Katz claims “a helical antenna placed over a ground plane, packaged in a case with a rigid cover . . . said helical antenna made of an elastic conductive spring configured to change its height along its axis . . . pressed down between said case and said cover . . . or extended to a higher height improving antenna gain upon removing said cover . . . ”

Still, the extended helical antenna is not robust enough to enable performing hard physical tasks such as rowing, hiking, skiing, and so on.

So, while present art solutions provide quite a compact device when the antenna is stowed, they fail from providing a device which could be practically handled when the antenna is deployed, and also fail to provide a simple and robust method to deploy the antenna, as is paramount in emergency situations.

Planar antennas and particularly loop antennas obtain a low profile, so theoretically could provide a good solution for compact personal devices.

U.S. Pat. No. 7,038,634 to Bisig discloses Optimization of a loop antenna geometry embedded in a wristband portion of a watch. Bisig focuses on a simple and robust method to match a loop antenna embedded in a wrist watch band, yet as it is applied to receive FM radio broadcast, such an antenna is not configured for high efficiency, as transmission antennas typically require.

Still, designing efficient loop antennas for relatively low frequency bands, as HF, VHF and low UHF, is quite challenging in compact dimensions. At 406 MHz, for example, the wavelength is 74 cm, and since an efficient loop antenna is typically about a wavelength in circumference, this will require a loop with 23.5 cm diameter, which is not practical for a wrist worn device or even hand held device.

Embedding an antenna in a substrate obtaining a dielectric constant larger than 1 (which is the dielectric constant in free space, and approximately the dielectric constant in air), can reduce the antenna size, for a given frequency, by the square root of the substrate dielectric constant, assuming that enough volume of this material is applied. Yet, such materials are usually expensive, heavy, and further narrow the band width of the antenna.

A balancing capacitor is a fair method to decrease the ESA dimensions, yet the high voltage usually generated on the capacitor terminals should be carefully considered.

A wrist worn device is particularly useful for Search and Rescue of people in distress situations. Such situations, by nature, appear when not precisely expected. For example, falling overboard a vessel, tackling a snow avalanche, been hurt by a wild animal, might happen when communication devices are not handy or out of range. In such scenarios, it is desirable that a Personal Locator Beacon (PLB), detectable by satellites, be attached to the body on a permanent basis. Naturally, a wrist worn PLB is a practical device in such cases. Furthermore, a small and efficient and robust antenna is vital for such applications.

Present art methods have not yet provided satisfactory solutions for portable communication devices, operating on a relatively low frequency, obtaining a compact and robust yet efficient antenna.

It is then an object of the present invention to provide a communication device and antenna and method for antenna deployment, practically and friendly carried and operated by a user, wherein said antenna obtains at least two positions: a) stowed, where the antenna is packaged in a small volume; b) operational, where the antenna is extended.

It is also an object of the present invention to provide a communication device and antenna and method for antenna deployment, wherein said antenna comprises a planar radiating element and a ground plane parallel to said radiating element, and said radiating element is configured to move close to and apart from said ground plane.

It is another object of the present invention to provide a communication device and antenna and method for antenna deployment, wherein said antenna is in form of a loop, and said loop is configured from a hollow or a flat conductor.

It is still an object of the present invention to provide a communication device and antenna and method for antenna deployment, wherein said antenna is in form of a loop, and a balancing capacitor is placed between the terminals of said loop in order to trim said antenna to a desired frequency, yet keeping said antenna with relatively small physical dimensions.

It is yet an object of the present invention to provide a communication device and antenna and method for antenna deployment, and configuring at least one of the feeding lines routed to said radiating element vertically to said ground plane.

It is yet another object of the present invention to provide a communication device and antenna and method for antenna deployment, for a wrist-worn emergency radio beacon, also known as a Personal Locator Beacon (PLB), particularly a PLB detectable by satellites.

Other objects and advantages of the invention will become apparent as the description proceeds.

### SUMMARY OF THE INVENTION

The present invention discloses a portable communication device comprising an extendable antenna, said antenna comprising a first substantially planar radiating element, and a ground plane, said first radiating element and said ground plane substantially parallel to each other, and the distance between said first radiating element and said ground plane configured to change, at least attaining two positions: a) stowed, in which said first radiating element is close to said ground plane; b) operational, in which said first radiating element is more apart from said ground plane, wherein the radiation pattern of said antenna in the operational position and in the stowed position are different compared to each other.

Typically, the disclosed antenna is tuned for optimal performance in the operational position. Optimal performance usually means: good matching (i.e. much of the RF power output from the transmitter goes to the antenna, and a small part of the RF power is reflected) at the operating frequency, good antenna efficiency (i.e. much of the RF power got by the antenna is radiated, and a small part of that RF power is dissipated on the antenna) and antenna directivity (e.g. Omnidirectional, directional, etc.) as desired. A wide band antenna is also desired. In this document, the scope of the term “radiation pattern” of an antenna covers the parameters: antenna matching, efficiency, directivity and band width.

(Usually, “antenna radiation pattern” is referred in the art as “directional dependence of the strength of the radio waves from the antenna”, but since antenna matching and antenna efficiency influence the strength of radio waves from the antenna, then the antenna radiation pattern depends on the matching and efficiency of the antenna, and naturally reflects also its directivity. The antenna band width also influences the radiation pattern, considering the strength of radio waves from the antenna at and around the operating frequency).

Preferably, said radiating element is made of at least one of: a) a hollow conductor configured in form of a loop; b) a flat conductor configured in form of a loop.

A hollow conductor, like a copper pipe or tube, is advantageously for having relatively a large surface, contributing to a low RF resistance considering the “skin effect”, and consequently high efficiency.

A flat conductor, preferably a copper trace on a Printed Circuit Board (PCB), is typically less efficient in terms of antenna radiation, but obviously obtains a lower profile and is easier to manufacture, compared to the tube.

For example, at 406 MHz, a loop antenna with an average diameter of 54 mm, is about 10% more efficient if made of a 6 mm diameter tube (¼″), compared to a 6 mm wide PCB trace.

Preferably, said radiating element is in form of a loop, either hollow or flat, and comprising a capacitor configured between the terminals of said loop to match said antenna to a desired frequency.

One significant advantage of the loop is that it leaves free space in and around its center, which may be utilized, in certain limits, for placing other components.

Typically, a capacitor of 1-3 pf is required to match a loop with an average diameter of 54 mm, to 406 MHz. Care must be taken to the relatively high voltage required from this capacitor.

As a person skilled in the art may appreciate, a resistor placed in parallel to said capacitor may decrease the antenna quality factor (Q) and accordingly increase its band width, traded off for lower antenna efficiency.

Preferably, at least one feeding line routed to said radiating element is substantially vertical to said ground plane. This way, the transmitter output is placed just below the loop, and when the antenna extends, the feeding line moves vertically, connecting the transmitter output to the loop in a straight vertical line.

Optionally, the disclosed device further comprises means to press said radiating element away from said ground plane, and holding means avoiding said radiating element from extending away from said ground plane. Then, the antenna automatically extends as soon as these holding means are removed.

Further optionally, the disclosed device is configured to automatically release said holding means, and enable antenna extension, upon an input signal from at least one of: a) an external device; b) an internal sensor comprised in said device. For example, biometric sensors comprised in the disclosed communication device may indicate that a person is in distress (e.g. too low pulse, extreme blood pressure, extreme body temperature), then provide a signal that releases said holding means.

Preferably, the disclosed device further comprises electrical contacts configured to switch said device on when said antenna is extended. This way, when the antenna is placed in the operational position, the device is automatically activated.

Preferably, the disclosed device comprises a second radiating element, configured at a fixed distance from said ground plane. Typically, this second radiating element is configured to receive GPS signals.

Preferably, the disclosed device is configured to be worn on the wrist, wherein said ground plane configured to be placed between said first radiating element and the human body. Such configuration is particularly useful for Personal Locator Beacons (PLBs) that alert when a person is in danger.

The present invention is also directed to an antenna comprising a first substantially planar radiating element, and a ground plane, said first radiating element and said ground plane substantially parallel to each other, and the distance between said first radiating element and said ground plane configured to change, at least attaining two positions: a) stowed, in which said first radiating element is close to said ground plane; b) operational, in which said first radiating element is more apart from said ground plane, wherein the radiation pattern of said antenna in the operational position and in the stowed position are different compared to each other.

Preferably, the disclosed antenna comprises a radiating element made of at least one of: a) a hollow conductor configured in form of a loop; b) a flat conductor configured in form of a loop.

Preferably, the disclosed antenna comprises a radiating element in form of a loop, and comprises also a capacitor configured between the terminals of said loop to match said antenna to a desired frequency.

Preferably, the disclosed antenna comprises at least one feeding line routed to said first radiating element substantially vertical to said ground plane.

Optionally, the disclosed antenna further comprises means to press said radiating element away from said ground plane, and holding means avoiding said radiating element from extending away from said ground plane.

Further optionally, the disclosed antenna is configured to automatically release said holding means, and enable antenna extension, controlled by an input from an external device.

Preferably, the disclosed antenna comprises a second radiating element, configured at a fixed distance from said ground plane. Typically, such second radiating element is configured to receive GPS signals.

Preferably, the disclosed antenna is configured to be comprised in a communication device worn on the wrist, wherein said ground plane configured to be placed between said first radiating element and the human body.

The present invention is further directed to a method for stowing and deploying an extendable antenna comprising the steps of:
a. configuring a substantially planar radiating element;
b. configuring a ground plane, substantially parallel to said radiating element;
c. configuring the distance between said first radiating element and said ground plane to change, at least attaining two positions: i) stowed, in which said first radiating element is close to said ground plane; ii) operational, in which said first radiating element is more apart from said ground plane, wherein the radiation pattern of said antenna in the operational position and in the stowed position are different compared to each other;
d. configuring at least one feeding line to said radiating element, substantially vertically to said ground plane.

Preferably, according to the disclosed method, said radiating element is made of at least one of: a) a hollow conductor configured in form of a loop; b) a flat conductor configured in form of a loop.

Preferably, according to the disclosed method, said radiating element is configured in form of a loop, and said antenna is configured to a desired frequency by a capacitor placed between the terminals of said loop.

Other objects and advantages of the invention will become apparent as the description proceeds.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 shows side views of an Extendable Antenna in two different positions: (a) stowed position, where the radiating element is close to the ground plane, and (b) operational position, where the antenna is extended and the radiating element is apart from the ground plane.

FIG. 2 shows an Extendable Antenna with Vertical Feeding. A side view of the antenna is depicted in the stowed (a) and extended (b) positions, indicating the feeding line(s) routed from the transmitter to the radiating element, and a top view (c) of the antenna indicates where a feeding line is connected to the radiating element, as well as a ground short used to match the antenna.

FIG. 3 shows a Hollow Loop Radiating Element, in top view (a) and side view (b). For 406 MHz, the loop is typically 50 mm in internal diameter, and the conductor is typically made of a hollow copper pipe, 6 mm in diameter.

FIG. 4 shows a Flat Loop Radiating Element, in top view (a) and side view (b). For 406 MHz, the loop is typically 50 mm in internal diameter, and the conductor is typically made of a PCB trace, 6 mm wide.

FIG. 5 shows top views of a Hollow Loop Radiating Element with Capacitor, depicting (a) a schematic capacitor soldered to the loop terminals, and depicting (b) a picture of an SMD Capacitor Soldered to the Loop terminals. For 406 MHz, the capacitor is typically 1-3 pf.

FIG. 6 shows top views of a Flat Loop Radiating Element with Capacitor, depicting (a) a schematic capacitor soldered to the loop terminals, and depicting (b) a picture of an SMD Capacitor Soldered to the Loop terminals. For 406 MHz, the capacitor is typically 1-3 pf.

FIG. 7 shows an Extendable Antenna with Pressing and Holding Means, in (a) Stowed position (side view), (b) Extended position (side view), and (c) top view. The figure depicts the pressing means as springs, configured between the radiating element and the ground plane, vertically to both planes. The springs are correspondingly configured over 4 guiding poles, to control the up and down movement of the radiating element compared to the ground plane.

In the stowed position (a), the springs are pressed, and in the operational position (b), the springs are extended. Further, holding means are depicted in form of holding pins, inserted in the guiding poles below the ground plane level, preventing from the radiating element from extending (a), but when these pins are released (b), the radiating element extends by the power of the springs.

FIG. 8 shows an Antenna according to the present invention, Worn on the Wrist (Communication Device not Shown). The ground plane of the antenna is depicted in between the radiating element and a human hand.

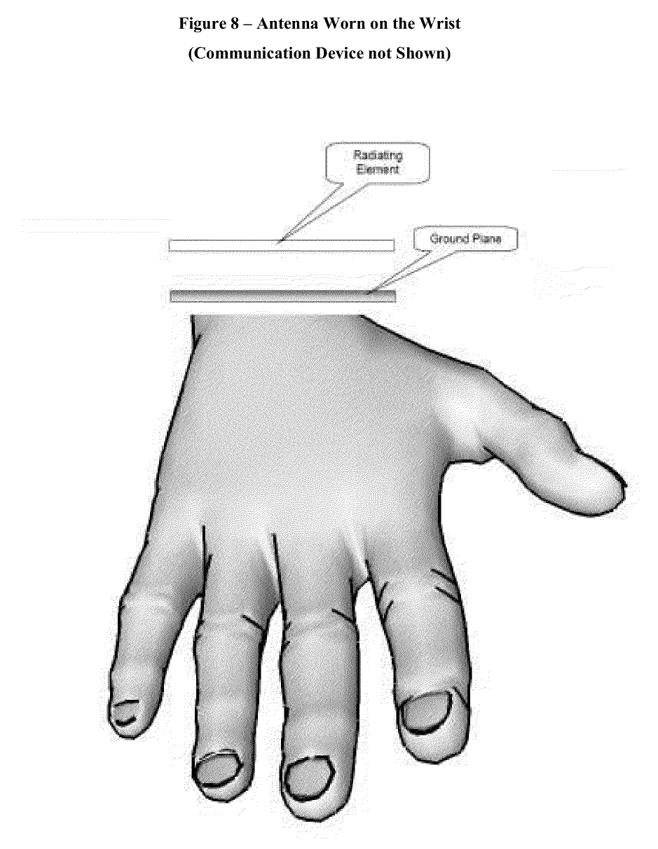

FIG. 9 shows a schematic Overview of a Wrist Worn Communication Device according to the present invention (casing and straps not shown), in background of Satellite System. The satellite system is depicted in form of three GPS satellites, transmitting navigation signals, and one Cospas-Sarsat satellite, which is a Search and Rescue (SAR) satellite that detects and relays to ground stations (not shown) distress signals transmitted at 406 MHz. Further, the picture depicts a human hand, on which a schematic communication device is shown. In the communication device, a ground plane is depicted, a first radiating element, typically tuned to transmit 406 MHz signals (UHF band), and a second radiating element, typically configured to receive the GPS signals on the L band.

FIG. 10 shows a Block Diagram of a Communication Device according to a preferred embodiment of the present invention, coupled with two Antennas. A first radiating element is depicted, coupled to a 406 MHz transmitter, and a second radiating element is depicted, coupled (via a SAW filter) to a GPS receiver. Both the 406 MHz transmitter and the GPS receiver are shown coupled to a microcontroller, shown also to obtain a human interface.

### DETAILED DESCRIPTION

The present invention discloses a portable communication device comprising an extendable antenna, said antenna comprising a first substantially planar radiating element, and a ground plane, said first radiating element and said ground plane substantially parallel to each other, and the distance between said first radiating element and said ground plane configured to change, at least attaining two positions: a) stowed, in which said first radiating element is close to said ground plane; b) operational, in which said first radiating element is more apart from said ground plane, wherein the radiation pattern of said antenna in the operational position and in the stowed position are different compared to each other.

Typically, the disclosed antenna is tuned for optimal performance in the operational position. Optimal performance usually means: good matching (i.e. much of the RF power output from the transmitter goes to the antenna, and a low amount of RF power is reflected) at the operating frequency, good antenna efficiency (i.e. much of the RF power got by the antenna is radiated, and a low amount of RF power is dissipated on the antenna) and antenna directivity (e.g. Omnidirectional, directional, etc.) as desired. A wide band antenna is also desired. In this document, the scope of the term “radiation pattern” of an antenna covers these four parameters: antenna matching, efficiency, directivity and band width, so “different radiation patterns” means that at least one of said four parameters is different, when measured in the operational position compared to this parameter measured in the stowed position.

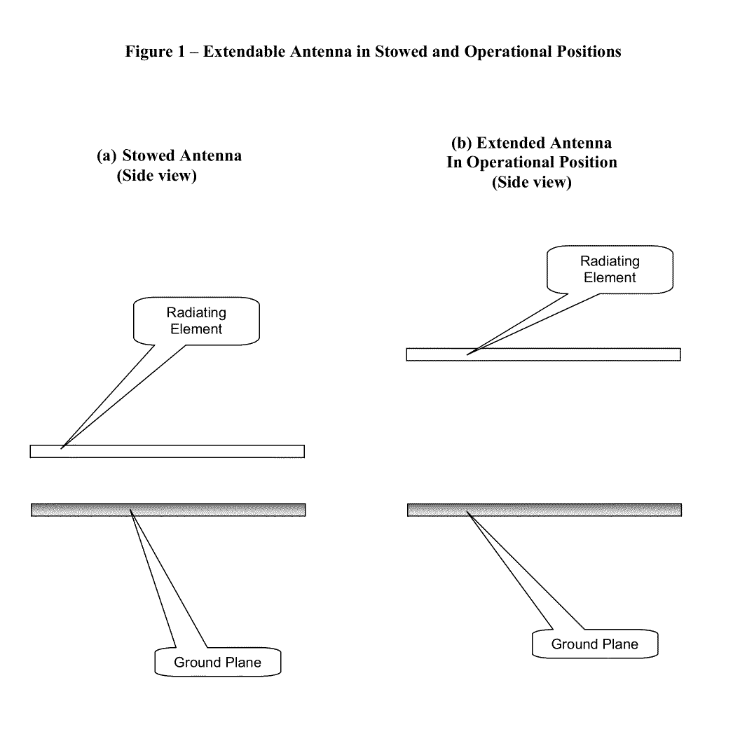

FIG. 1 shows side views of an Extendable Antenna in two different positions: (a) stowed position, where the radiating element is close to the ground plane, and (b) operational position, where the antenna is extended and the radiating element is apart from the ground plane.

Preferably, for a 406 MHz antenna, the distance between the radiating element and the ground plane in the operational position is 15-20 mm, and in the stowed position this distance is smaller as practically possible.

The planar antenna, as a person skilled in the art may appreciate, can be of various types, such as but not limited to: loop, meander, inverted-F (PIFA), patch, folded monopole or dipole, spiral, slot, etc.

According to a first (preferred) embodiment of the present invention, said radiating element is made of a hollow conductor configured in form of a loop.

As a person skilled in the art may appreciate, a “loop” antenna may be configured in various shapes, such as but not limited to: circle, ellipse, rectangle, square, triangle, octagon, hexagon, and so on.

According to a second embodiment of the present invention, said radiating element is made of a flat conductor configured in form of a loop.

According to a third embodiment of the present invention, said radiating element is made of a solid conductor configured in form of a loop.

According to said first and second and third embodiments, the antenna is configured to operate in the band of 406.0-406.1 MHz (at least), which is the band allocated to the Cospas-Sarsat Search and Rescue (SAR) satellite system.

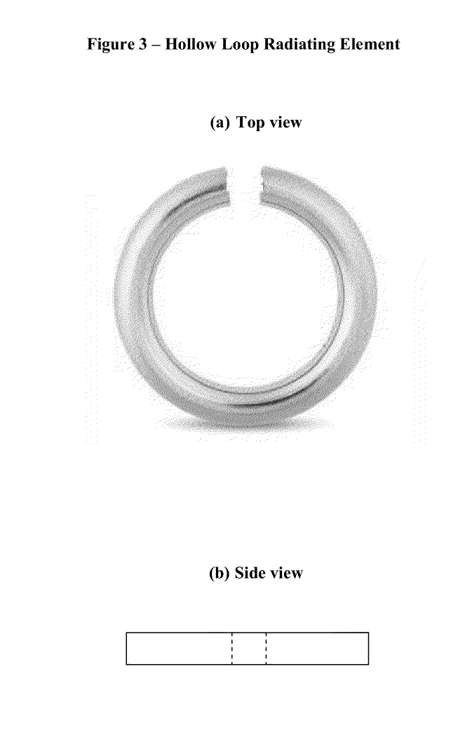

According to said first embodiment, the first radiating element is made of a hollow copper pipe with external diameter of 6 mm (¼ inch) and internal diameter of 4 mm, bent into a loop (circle) with an internal diameter of 50 mm. This loop is not closed, and a gap of about 2 mm is kept between its terminals, as shown in FIG. 3 (a).

FIG. 3 shows a Hollow Loop Radiating Element, according to the first embodiment of the present invention, in top view (a) and side view (b).

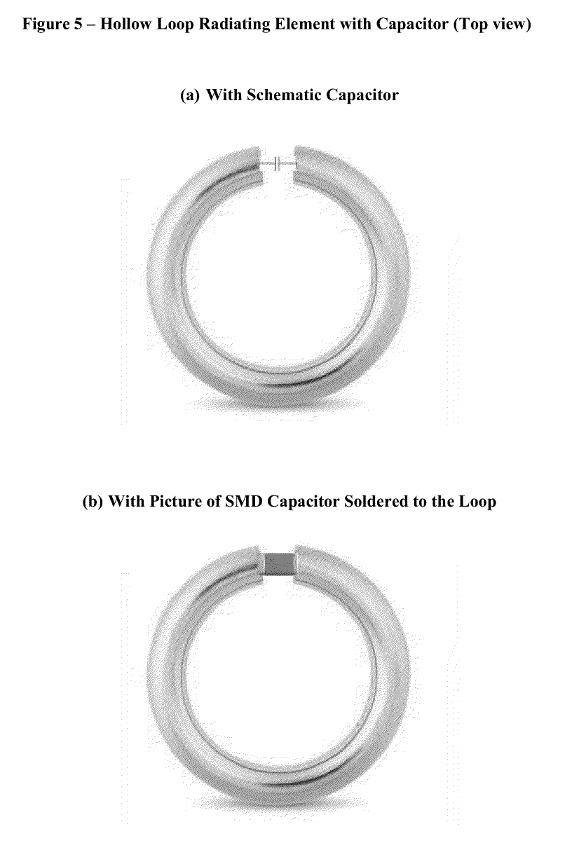

Further according to the first embodiment of the present invention, a capacitor of 1-3 pf is soldered between said loop terminals, as shown in FIG. 5.

Optionally, a resistor is placed in parallel to said capacitor to decrease the antenna quality factor (Q) and accordingly increase its band width, traded off for lower antenna efficiency.

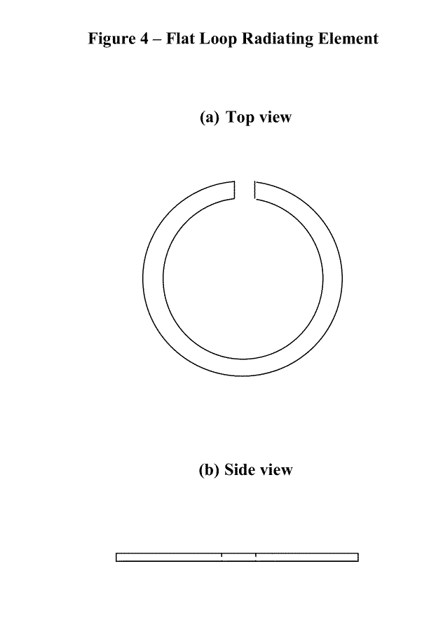

According to said second embodiment, the first radiating element is made of a flat copper PCB trace with 6 mm of width, in form of a loop (circle) with an internal diameter of 50 mm. This loop is not closed, and a gap of about 2 mm is kept between its terminals, as shown in FIG. 4 (a).

FIG. 4 shows a flat Loop Radiating Element, according to the second embodiment of the present invention, in top view (a) and side view (b).

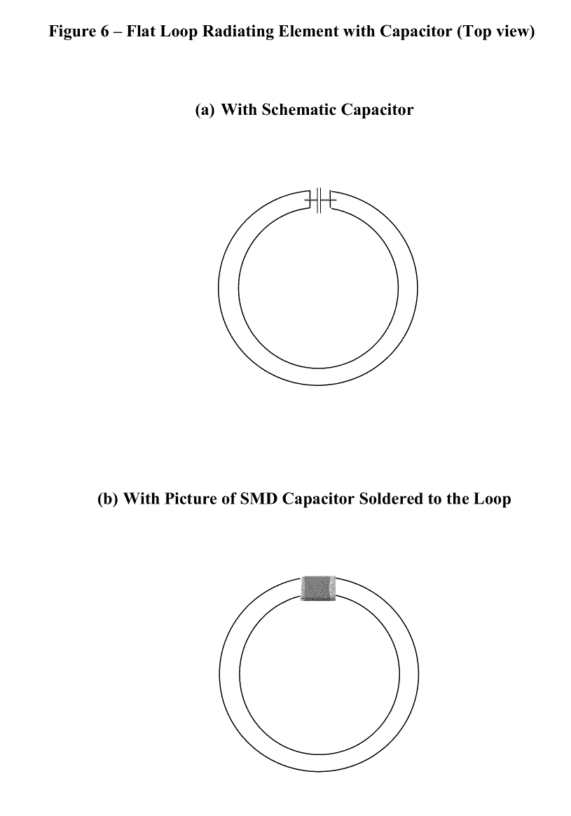

Further according to the second embodiment of the present invention, a capacitor of 1-3 pf is soldered between said loop terminals, as shown in FIG. 6.

Optionally, a resistor is placed in parallel to said capacitor to decrease the antenna quality factor (Q) and accordingly increase its band width, traded off for lower antenna efficiency.

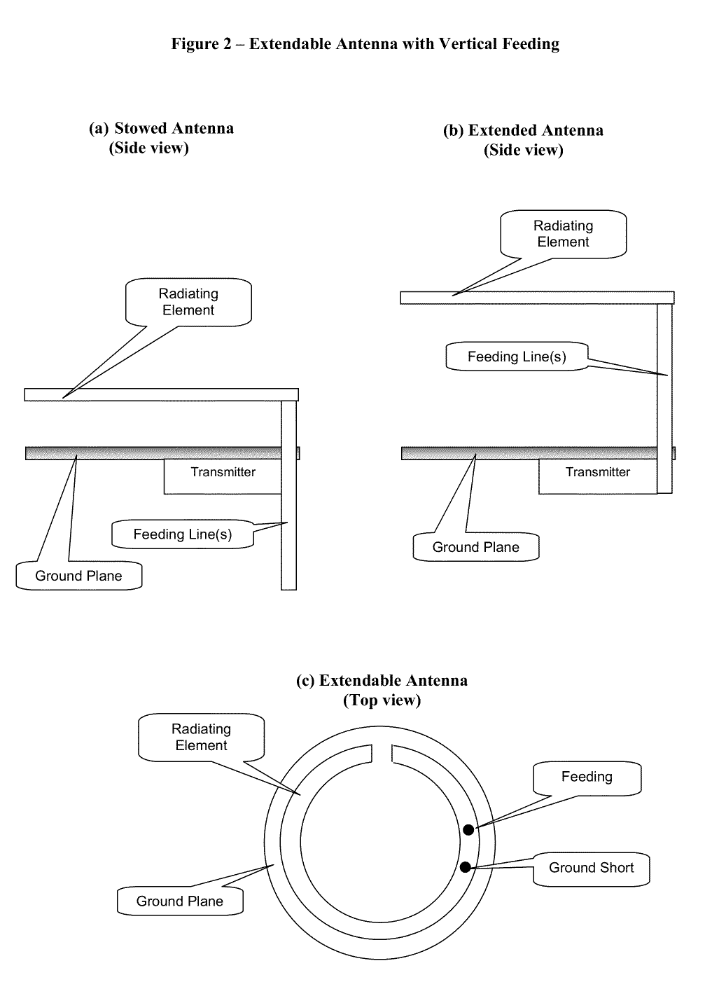

FIG. 2 shows an Extendable Antenna with Vertical Feeding, according to the first and second and third embodiments of the present invention. A side view of the antenna is depicted in the stowed (a) and extended (b) positions, indicating the feeding line(s) routed from the transmitter to the radiating element, and a top view (c) of the antenna indicating where the feeding line is connected to the radiating element, as well as a ground short used to match the antenna. As a person skilled in the art may appreciate, the transmitter which is depicted on the bottom side of the ground plane, may alternatively be placed on the top side of the ground plane.

Though FIG. 2 (c) depicts the loop (radiating element) with a smaller external diameter than the ground plane, this is not mandatory, and it is well possible that the ground plane diameter be smaller than the loop external and even internal diameter.

According to said first and second and third embodiments, a 406 MHz transmitter is implemented on top (or on bottom) of the ground plane and one feeding line is configured between said transmitter and the first radiating element. In addition to that feeding line, a ground short is configured between the ground plane and the first radiating element (i.e. the loop). This ground short is a conductor placed in parallel to the feeding line and about 1 cm aside it. This feeding scheme, as a person skilled in the art may appreciate, is a form of matching an antenna, usually referred in the art as tap match or tapped feeding or tapped connection.

Preferably, both the feeding line and ground short are soldered to the radiating element, but not rigidly attached to the transmitter and ground plane, correspondingly. Rather, as shown in FIG. 2, the feeding line can move along the transmitter output, and make a contact between said transmitter output and the radiating element, at least in the operational position. Similarly, the ground short conductor can move relatively to the ground plane, and make a contact between said ground plane and the radiating element at least in the operational position.

According to one aspect of the present invention, the disclosed device further comprises means to press said radiating element away from said ground plane, and holding means avoiding said radiating element from extending away from said ground plane. Then, the antenna automatically extends as soon as these holding means are removed.

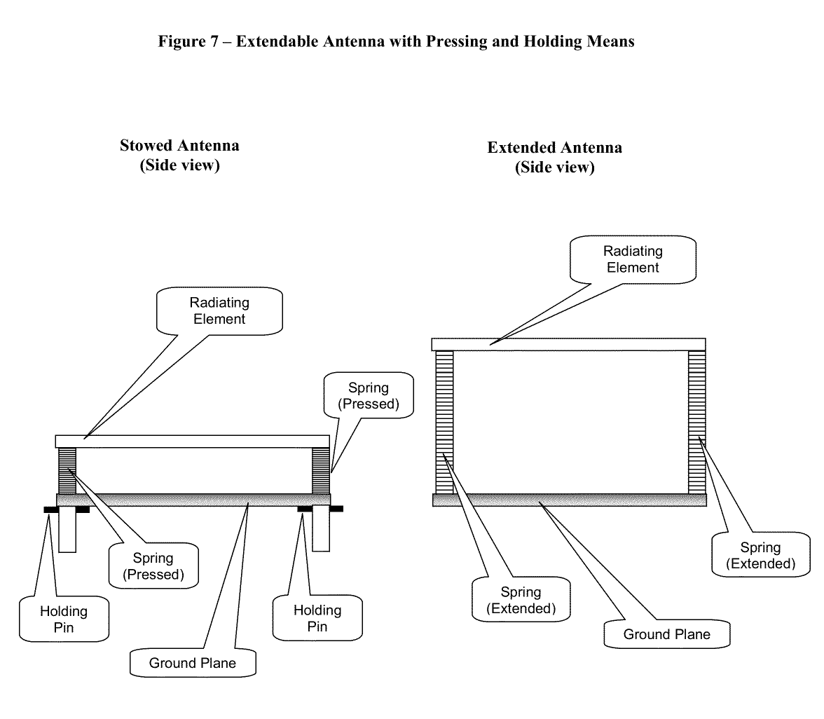

FIG. 7 shows an Extendable Antenna with Pressing and Holding Means, in (a) Stowed position (side view), (b) Extended position (side view), and (c) top view. The figure depicts the pressing means as springs, configured between the radiating element and the ground plane, vertically to both planes. The springs are correspondingly configured over 4 guiding poles, to control the up and down movement of the radiating element relatively to the ground plane.

In the stowed position (a), the springs are pressed, and in the operational position (b), the springs are extended. Further, holding means are depicted in FIG. 7 in form of holding pins, inserted in the guiding poles below the ground plane level, preventing the radiating element from extending (a), but when these pins are released (b), the radiating element is forced to extend by the springs.

As a person skilled in the art may appreciate, each of the springs and holding pins and guiding poles (all shown in FIG. 7), can be made either of conductive or non conductive material. According to the first and second and third embodiments of the present invention, the springs are not conductive, but two of the guiding poles (on the right side of FIG. 7-c) are conductive, and used, in addition to their mechanical function, as the feeding line and ground short, correspondingly. The other two guiding poles are not conductive.

Holding pins can be inserted in all of the guiding poles, or alternatively only in some poles, e.g. one or two of the poles. According to one aspect of the present invention, the disclosed device is configured to automatically release said holding pins, and enable antenna extension, upon an input signal from at least one of: a) an external device; b) an internal sensor comprised in said device.

Preferably, biometric sensors that monitor the pulse, blood pressure and body temperature, are comprised in the disclosed communication device, and if indicating that a person is in distress, provide a signal that releases said holding pins. This signal is amplified, and applied to an electromagnet, that when activated, pull the holding pins which are made of a material sensitive to those electromagnetic field, out of the guiding poles.

Preferably, the disclosed device further comprises electrical contacts configured to switch on said device when said antenna is extended. This way, when the antenna is placed in the operational position, the device is activated. Such contacts may be configured on one of the non conductive guiding poles (the two on the left side depicted in FIG. 7-c), aligned with counterparts on the PCB, such that when the antenna is in the extended position, the contacts on said guiding pole and on the PCB align and close a circuit that activates the disclosed device.

Preferably, the disclosed device comprises a second radiating element, configured at a fixed distance from said ground plane. Typically, this second radiating element is a GPS antenna placed on top of the ground plane, facing the open sky.

Preferably, the disclosed device is configured to be worn on the wrist, wherein said ground plane configured to be placed between said first radiating element and the human body.

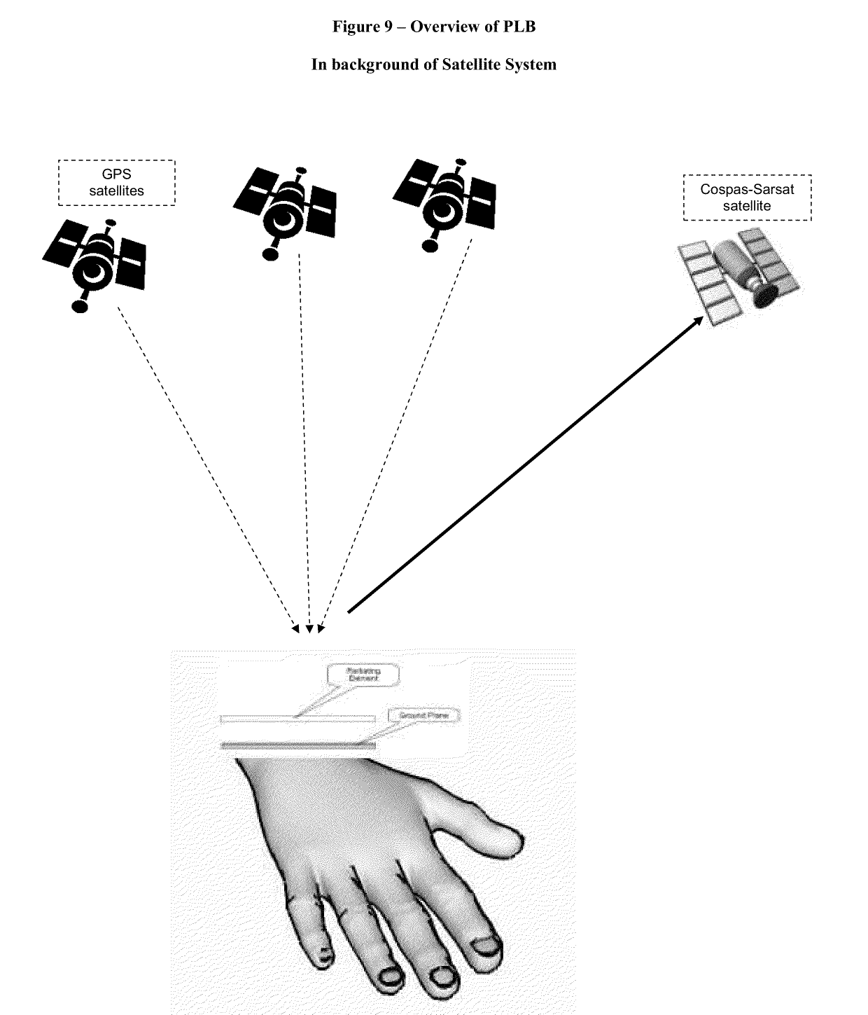

FIG. 9 shows an Overview of a Wrist Worn Communication Device according to the present invention, in background of a Satellite System. The satellite system is depicted in form of three GPS satellites, transmitting navigation signals, and one Cospas-Sarsat satellite, which is a Search and Rescue (SAR) satellite that detects and relays to ground stations (not shown) distress signals transmitted at 406 MHz. Further, the picture depicts a human hand, on which a schematic communication device is shown. In the communication device, a ground plane is depicted, a first radiating element, typically tuned to transmit 406 MHz signals (UHF band), and a second radiating element, typically configured to receive the GPS signals on the L band.

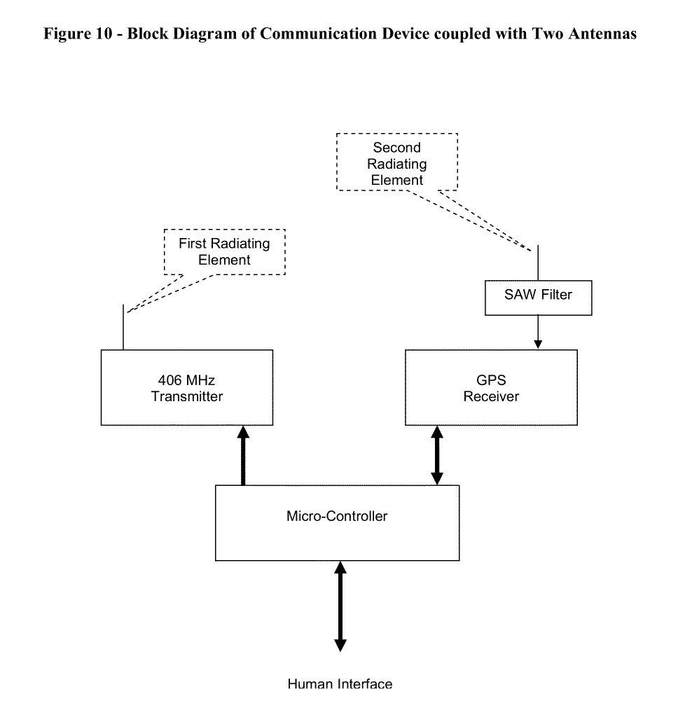

FIG. 10 shows a Block Diagram of a Communication Device according to the present invention, coupled with Two Antennas. A first radiating element is depicted, coupled to a 406 MHz transmitter, and a second radiating element is depicted, coupled (via a SAW filter) to a GPS receiver. Both the 406 MHz transmitter and the GPS receiver are shown coupled to a microcontroller, shown also to obtain a human interface.

The present invention is also directed to an antenna comprising a first substantially planar radiating element, and a ground plane, said first radiating element and said ground plane substantially parallel to each other, and the distance between said first radiating element and said ground plane configured to change, at least attaining two positions: a) stowed, in which said first radiating element is close to said ground plane; b) operational, in which said first radiating element is more apart from said ground plane, wherein the radiation pattern of said antenna in the operational position and in the stowed position are different compared to each other.

Preferably, the disclosed antenna comprises a radiating element made of at least one of: a) a hollow conductor configured in form of a loop; b) a flat conductor configured in form of a loop.

Preferably, the disclosed antenna comprises a radiating element in form of a loop, and comprises also a capacitor configured between the terminals of said loop to match said antenna to a desired frequency.

Preferably, the disclosed antenna comprises at least one feeding line routed to said first radiating element substantially vertically to said ground plane.

Optionally, the disclosed antenna further comprises means to press said radiating element away from said ground plane, and holding means avoiding said radiating element from extending away from said ground plane.

Further optionally, the disclosed antenna is configured to automatically release said holding means, and enable antenna extension, controlled by an input from an external device.

Preferably, the disclosed antenna comprises a second radiating element, configured at a fixed distance from said ground plane. Typically, such second radiating element is configured to receive GPS signals.

Preferably, the disclosed antenna is configured to be comprised in a communication device worn on the wrist, wherein said ground plane configured to be placed between said first radiating element and the human body.

The present invention is further directed to a method for stowing and deploying an extendable antenna comprising the steps of:
a. configuring a substantially planar radiating element;
b. configuring a ground plane, substantially parallel to said radiating element;
c. configuring the distance between said first radiating element and said ground plane to change, at least attaining two positions: i) stowed, in which said first radiating element is close to said ground plane; ii) operational, in which said first radiating element is more apart from said ground plane, wherein the radiation pattern of said antenna in the operational position and in the stowed position are different compared to each other;
d. configuring at least one feeding line to said radiating element, substantially vertically to said ground plane.

Preferably, according to the disclosed method, said radiating element is made of at least one of: a) a hollow conductor configured in form of a loop; b) a flat conductor configured in form of a loop.

Preferably, according to the disclosed method, said radiating element is configured in form of a loop, and said antenna is configured to a desired frequency by a capacitor placed between the terminals of said loop.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention. In this context, though the invention specifically refers to the Cospas-Sarsat satellite system, it is definitely not bounded to this particular system, and its scope is well beyond any specific communication or navigation system or any specific radio type or system or frequency.

The invention claimed is:

1. A portable communication device comprising an extendable antenna, said antenna comprising a first substantially planar radiating element, and a ground plane, said first radiating element and said ground plane substantially parallel to each other, and the distance between said first radiating element and said ground plane configured to change, at least attaining two positions: a) stowed, in which said first radiating element is close to said ground plane; b) operational, in which said first radiating element is more apart from said ground plane, wherein the radiation pattern of said antenna in the operational position and in the stowed position are different compared to each other.

2. A device according to claim 1, said radiating element made of at least one of: a) a hollow conductor configured in form of a loop; b) a flat conductor configured in form of a loop.

3. A device according to claim 1, said radiating element in form of a loop, and comprising a capacitor configured between the terminals of said loop to match said antenna to a desired frequency.

4. A device according to claim 1, wherein at least one feeding line routed to said radiating element is substantially vertical to said ground plane.

5. A device according to claim 1, further comprising means to press said radiating element away from said ground plane, and holding means avoiding said radiating element from extending away from said ground plane.

6. A device according to claim 6, configured to automatically release said holding means, and enable antenna extension, upon an input signal from at least one of: a) an external device; b) an internal sensor comprised in said device.

7. A device according to claim 1, further comprising electrical contacts configured to switch on said device when said antenna is extended.

8. A device according to claim 1, comprising a second radiating element, configured at a fixed distance from said ground plane.

9. A device according to claim 1, configured to be worn on the wrist, wherein said ground plane configured to be placed between said first radiating element and the human body.

10. An antenna comprising a first substantially planar radiating element, and a ground plane, said first radiating element and said ground plane substantially parallel to each other, and the distance between said first radiating element and said ground plane configured to change, at least attaining two positions:
a) stowed, in which said first radiating element is close to said ground plane; b) operational, in which said first radiating element is more apart from said ground plane, wherein the radiation pattern of said antenna in the operational position and in the stowed position are different compared to each other.

11. An antenna according to claim 10, said radiating element made of at least one of: a) a hollow conductor configured in form of a loop; b) a flat conductor configured in form of a loop.

12. An antenna according to claim 10, said radiating element in form of a loop, and comprising a capacitor configured between the terminals of said loop to match said antenna to a desired frequency.

13. An antenna according to claim 10, wherein at least one feeding line routed to said first radiating element is substantially vertical to said ground plane.

14. An antenna according to claim 10, further comprising means to press said radiating element away from said ground plane, and holding means avoiding said radiating element from extending away from said ground plane.

15. An antenna according to claim 14, configured to automatically release said holding means, and enable antenna extension, controlled by an input from an external device.

16. An antenna according to claim 10, comprising a second radiating element, configured at a fixed distance from said ground plane.

17. An antenna according to claim 10, configured to be comprised in a communication device worn on the wrist, wherein said ground plane configured to be placed between said first radiating element and the human body.

18. A method for stowing and deploying an extendable antenna comprising the steps of:
a. configuring a substantially planar radiating element;
b. configuring a ground plane, substantially parallel to said radiating element;
c. configuring the distance between said first radiating element and said ground plane to change, at least attaining two positions: i) stowed, in which said first radiating element is close to said ground plane; ii) operational, in which said first radiating element is more apart from said ground plane, wherein the radiation pattern of said antenna in the operational position and in the stowed position are different compared to each other;
d. configuring at least one feeding line to said radiating element, substantially vertically to said ground plane.

19. A method according to claim 18, wherein said radiating element made of at least one of: a) a hollow conductor configured in form of a loop; b) a flat conductor configured in form of a loop.

20. A method according to claim 18, further configuring said radiating element in form of a loop, and configuring said antenna to a desired frequency by a capacitor placed between the terminals of said loop.
